(19) United States
(12) Patent Application Publication
(10) Pub. No.: US 2009/0139454 A1
(43) Pub. Date: Jun. 4, 2009

(54) FORAGING FEEDING SYSTEM FOR CAPTIVE BIRDS

(76) Inventor: Taishan Gao, New Market, MD (US)

Correspondence Address: JONES, TULLAR & COOPER, P.C., P.O. BOX 2266 EADS STATION, ARLINGTON, VA, 22202, US

(21) Appl. No.: 11/948,929

(22) Filed: Nov. 30, 2007

(51) Int. Cl. A01K 39/014

(52) U.S. Cl. 119/53.5

(57) ABSTRACT

A feeding system for captive birds combines the activity of foraging with feeding in a manner that can be easily managed and used by the bird's owner or caretaker. The system includes a disposable feeder box made of frangible edible material for storing food and a mounting system for mounting the box to an inside surface of a bird cage.

### BACKGROUND OF THE INVENTION

1. Field of the Invention

The present invention relates to an inexpensive, easy to use system for feeding captive birds which requires the birds to work for their food as they would in the wild. The extra activity required to access the food keeps the birds healthier and less likely to exhibit emotional problems.

2. Discussion of the Background Art

Recently, the pet bird industry has become aware of the importance of foraging for captive birds. Foraging is the activity of searching and finding food. In the wild, it is common for birds to spend much of their day foraging for food. The birds move from place to place seeking, probing, tearing and discovering edible foods. In other words, they work for their meals, which keeps their mental and physical abilities challenged at all times. In their natural habitat, birds, especially large beaked birds such as parrots, have a natural instinct and a need to search for food, such as berries and nuts. After the more readily available supplies are gone, this requires that the birds search in less accessible locations in order to find such food. Also, large beaked birds in the wild constantly exercise, strengthen their jaws and sharpen their beaks by chewing and destroying the wood of trees and shrubs.

On the other hand, captive pet birds usually have food readily provided for them at all times. Foraging and normal feeding behaviors are thus eliminated. Often, the resulting lack of activity results in boredom, lack of natural curiosity and other emotional problems. This occurs because the only activities left for a bird after foraging and feeding are social interactions, feather care and sleep. As a result, captive pet birds often exhibit undesirable behavioral characteristics including excessive feather picking and deterioration of physical and mental abilities.

In an effort to address the foregoing problems, a variety of bird exercisers and amusement toys have been marketed for domestic caged birds. The theory behind these devices is that the bird will spend more time playing with the toys, which will take up much of the time normally used by birds in the wild for foraging. However, it has been discovered that provisions of these toys and exercise devices still do not eliminate the aforementioned behavioral problems in captive birds. Presumably, this is because the devices still do not involve the actual act of foraging.

Foraging toys have now appeared on the market which require a bird to search for and then actively work to retrieve a treat or other reward. Typically, a foraging toy includes an enclosure containing a treat or reward to be retrieved by the bird. A window or opening is usually provided that allows a bird to see what is inside but not to access the treat or other item without significant effort. To gain access to the treat the bird must either tear away a portion of the device or figure out how to open a door or other means to gain access to window in the device. These devices are intended to stimulate the foraging instinct of the bird to some extent, but are not designed to replace conventional feeding devices.

In conventional feeding devices, the feeding aspect of the device is its sole function. The food is readily visible and accessible, and its access requires only nominal effort by the bird or animal. As long as a bird's normal supply of food is readily available in this manner, foraging toys can only improve the bird's well being to a small extent. However, the feeding of a pet bird represents a significant expense that would be increased further if the feeding process were to involve a complicated design to simulate foraging. Further, the added upkeep of a foraging based feeding system could deter many bird owners from considering such a feeding system. What is therefore needed is a bird feeding system which combines the foraging concept with a conventional feeding device in a simple, inexpensive manner.

### SUMMARY OF THE INVENTION

The present invention fulfills the foregoing need through provision of a feeding system for captive birds that combines the activity of foraging with feeding in a manner that is inexpensive and can be easily managed and used by the bird's owner. Unlike known foraging toys, the feeding system is designed not to supplement the bird's normal food supply, but to replace the readily accessible food supply completely with a supply that requires the bird to work for its food.

The feeding system includes a replaceable frangible container for storing food and a mounting system for mounting the frangible container to an inside surface of a bird cage in one or more positions. Preferably, the frangible container is a box that is made from edible material, such as food grade cardboard or chipboard. The box is preferably formed from an inexpensive flat blank that includes a tab and slot securing arrangement that avoids the need for toxic adhesives or glue to hold the box in an assembled condition. One or more small perforated sections are formed on one or more outer surfaces of the box which can be removed by the bird owner to allow the bird to view the contents of the box without being able to access them. Once the bird learns that food is contained in the box, the perforated sections can be left in place when a new box of food is provide to the bird.

To simplify use of the feeding system by the bird's owner or caretaker, the mounting system preferably includes a flat base having a threaded shank that is sized to pass through an opening in the cage wires and be secured to the cage by a thumb nut. A receptacle portion of the mounting system receives the frangible feeding box and is the secured to the base, preferably by a pair of tab and slot snap connectors. The receptacle portion includes one or more openings that allow a bird to gain access to the exposed surface or surfaces of the frangible box.

Preferably, the frangible box includes a plurality of compartments that are formed by dividers inside the box. These dividers require a bird to work repeatedly through the dividers to access the various compartments. A variety of food, treats, toys etc, can be provided in the various compartments if desired.

Once the bird has consumed the contents of the box, the owner removes any remains of the feeder box and replaces it with a new box by unsnapping the mounting cover, inserting the new box and re-snapping the cover in place.

Preferably, the system can be mounted in more than one way inside the bird cage to provide a variety of access positions that the birds must accommodate. As an example, a plurality of the feeding systems can be provided, each mounted in a different manner inside the cage, to provide a variety of challenges for the bird or birds.

### BRIEF DESCRIPTION OF THE DRAWINGS

The features and advantages of the present invention will become apparent from the following detailed description of a preferred embodiment thereof taken in conjunction with the accompanying drawings which are briefly described as follows.

FIGS. 1A-1C are front perspective, back perspective and exploded front perspective views, respectively, of a foraging bird feeding system constructed in accordance with the preferred embodiment of the present invention.

FIGS. 2A-2C are front perspective, back perspective and exploded front perspective views, respectively, of a variation of the preferred embodiment of the present invention which employs a different feeder box cover to facilitate mounting of the feeder box to a bird cage side wall in a vertical position which allows access to the feeder box through three open sides of the cover.

FIG. 3 is a top view of a box blank employed to form the feeder boxes of the preferred embodiment.

### DETAILED DESCRIPTION OF THE INVENTION

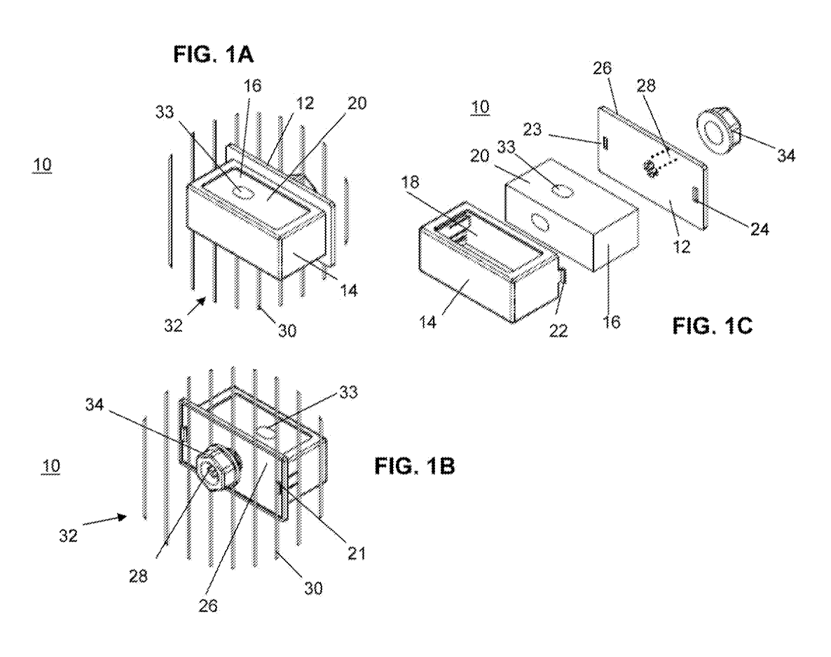

With reference now to a more detailed consideration of the present invention, FIGS. 1A-1C illustrate a foraging bird feeder system 10 that is constructed in accordance with a preferred embodiment of the invention. The system 10 includes a base plate 12, a cover 14 and a disposable feeder box 16. The cover 14 fits over the box 16 and includes an opening 18 for exposing a top surface 20 of the feeder box 16 to facilitate access thereto by a bird. First and second flexible tabs 21 and 22 depend from first and second ends of the cover 14 that engage and snap into first and second corresponding slots 23 and 24 in the base plate 12 to secure the cover 14 thereto. Extending from a backside 26 of the base plate 12 is a threaded shank 28 which is sized so that it can pass through the space between two cage wires 30 of a cage sidewall 32. A threaded nut 34, which preferably can be hand tightened, is threaded onto the shank 28 to secure the feeder system 10 to the sidewall 32 of the cage by crimping the cage wires 30 between the nut 34 and the backside 26 of the base plate 12.

The feeder box 16 is preferably made from a frangible, edible material such as thin food grade cardboard or chipboard that can be torn, chewed and consumed by a bird without any deleterious side effects. It should be noted that the term “edible” does not necessarily imply that the box material has food value, but is used here to mainly to mean that the material can be consumed by a bird without adverse effects on the bird as mentioned.

In addition, one or more removable perforated sections 33 are preferably provided on one or more of the outside surfaces of the feeder box 16. The sections 33 are sized so that when they are removed, a bird can view the contents of the feeder box 16, but cannot access the contents without removing additional material from the box 16. When first using the feeder system 10, a bird owner or caretaker can remove the sections 33 to assist their bird in understanding that food is present in the feeder box 16. Once the bird is familiar with the system 10, the owner can leave the perforated sections 33 in place when replacing the feeder box 16 because the bird now knows that food is in the box 16 and will peck or chew through the box 16 without further coaxing.

Unlike the feeder box 16, the base plate 12 and feeder box cover 14 are preferably made of durable non-frangible “bird proof” material, such as high impact polycarbonate plastic, for example. The material for the cover 14 should be pliable enough, however, that the tabs 20 and 21 can flex and allow for easy snapping and unsnapping of the cover 14 onto and off of the base plate 12.

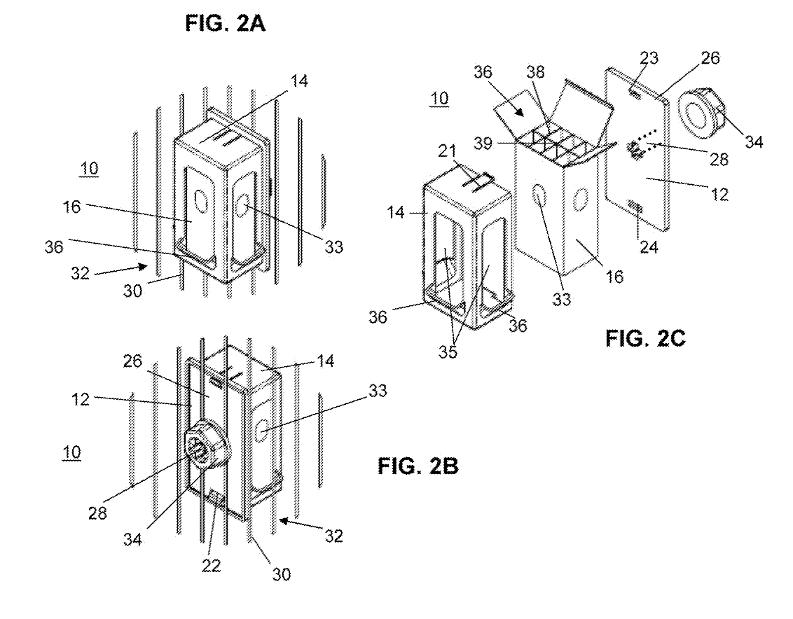

In the variation of the invention shown in FIGS. 2A-2C, the system 10 includes the same elements as in the FIG. 1 variation except for the feeder box cover 14. In this variation, which is designed to be mounted at a 90 degree angle relative to the FIG. 1 embodiment, the cover 14 includes three openings 35 instead of one and small trays 36 extend from the bottoms of the openings 35 to allow a bird to perch on the cover 14. The trays 36 also catch some of the food that invariably drops as the bird forages through the feeder box 16. FIG. 2C also shows the interior 37 of the feeder box 16, which includes a plurality of compartments 38 that are formed from a honeycomb shaped cardboard or chipboard divider assembly 39.

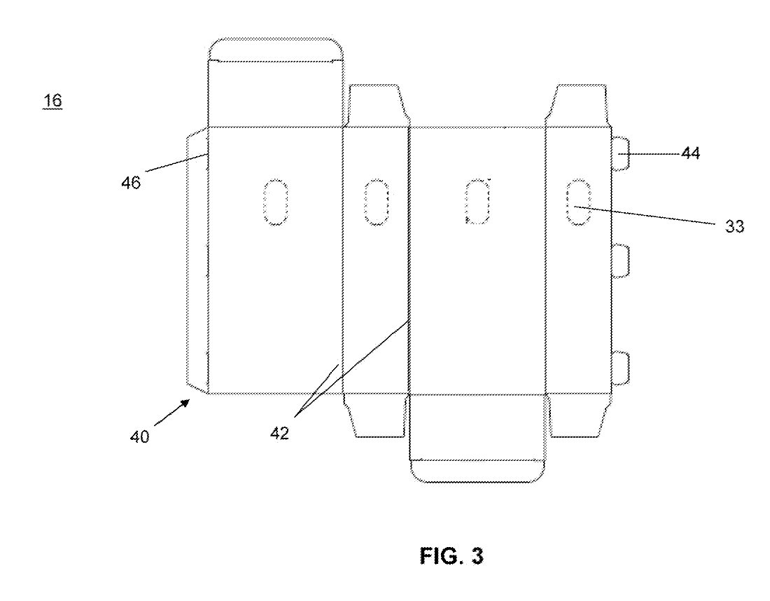

As illustrated in FIG. 3, the feeder box 16 is preferably formed from an inexpensive flat box blank 40 that is assembled by folding along a number of crease lines 42. The assembled box is secured together with a plurality of tabs 44 and slots 46. This arrangement eliminates the need for glue to hold the box together, which eliminates any potential that a bird would be exposed to a toxic substance.

To use the system, the bird owner first mounts the base plate 12 in any desired location to the inner surface of the cage sidewall 32. Preferably, the system can be mounted in more than one way inside the bird cage to provide a variety of access positions that the birds must accommodate. In this way, a plurality of the feeding systems can be provided, each mounted in a different manner inside the cage, to provide a variety of challenges for the bird or birds that encourage environmental exploration and present numerous reward opportunities.

A full feeder box 16 is then inserted into the cover 14 and the cover 14 is secured to the base plate 12 with the tab and slot arrangement. If desired, the one or more perforated sections 33 are removed by the owner so that the bird can view the contents of the feeder box 16. In the use of the invention, the bird must break through the frangible surface of the feeder box 16 to gain access to the food therein. If the perforated sections 33 are first removed, the resulting openings provide an easy starting point for the bird to begin tearing into the box 16. This process must be repeated each time the bird wants to access another compartment in the feeder box 16. In this manner, the bird must chew into the box 16 to find the food or other reward. Use of the compartmentalized box 16 thus encourages birds to learn eagerly that they must continue working to expose additional food. Because the birds spend more time engaging in healthy, time consuming foraging behavior, there is less time available for peripheral displacement activities and/or other potentially harmful or undesirable behaviors such as feather picking, excessive screeching etc. Once the bird has consumed the contents of the box 16, the owner removes any remains of the feeder box and replaces it with a new box by unsnapping the mounting cover 14, inserting the new box 16 and re-snapping the cover 14 in place.

While the invention has been particularly shown, described and illustrated in detail with reference to a preferred embodiment and modifications thereof, it should be understood by those skilled in the art that the foregoing and other modifications are exemplary only, and that equivalent changes in form and detail may be made without departing from the scope of the invention set forth in the following claims.

1. A foraging feeding system comprising:
a feeder box constructed of frangible, edible material, said feeder box including an interior;
a frangible, edible divider disposed in the interior of said box that separates said interior into a plurality of compartments;
a cover formed of non-frangible material for receiving said feeder box, said cover having at least one opening therein to allow access to said at least one outer surface of said feeder box; and
means for securing said cover and said feeder box to an inside surface of a cage.

2. The foraging feeding system of claim 1 further comprising:
a base plate including means for attaching said plate to an inside surface of a cage formed from spaced cage wires; and
means for removably attaching said cover to said base plate to secure said cover and feeder box to an inside surface of a cage.

3. The foraging feeding system of claim 2, wherein said means for removably attaching said cover to said base plate comprises first and second depending tabs on said cover that engage and first and second corresponding slots in said base plate.

4. The foraging feeding system of claim 2, wherein said means for attaching said base plate to an inside surface of a cage comprise a threaded shank extending from a backside of said base plate and sized to fit between two adjacent cage wires of said cage sidewall; and, a nut threaded on said shank for securing said plate by crimping said cage wires between said base plate and said nut.

5. The foraging feeding system of claim 1, wherein said feeder box includes at least one perforated section on said top surface that can be removed to expose contents of said box, said section being sized to prevent a bird from accessing the contents of said box without enlarging the opening made by removal of said section.

6. The foraging feeding system of claim 1, wherein said feeder box is made of a material selected from the group comprising cardboard and chipboard.

7. The foraging feeding system of claim 1, wherein said cover further includes a catch tray extending from a bottom side of said opening.

8. The foraging feeding system of claim 1, wherein said feeder box is formed from a flat box blank that is assembled by folding said blank along a number of crease lines and said blank includes a plurality of tab/slot pairs that secure the box in an assembled form without the need for glue or other potentially toxic material.
